(19) United States
(12) Patent Application Publication
(10) Pub. No.: US 2010/0208958 A1
(43) Pub. Date: Aug. 19, 2010

(54) IMAGE PROCESSING DEVICE, IMAGE PROCESSING SYSTEM, AND COMPUTER READABLE MEDIUM

(75) Inventors: Hideyuki Yamada, Kanagawa (JP); Akira Hasegawa, San Jose, CA (US)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/705,986

(22) Filed: Feb. 16, 2010

(30) Foreign Application Priority Data
Feb. 18, 2009 (JP) 2009-035380

(51) Int. Cl. G06K 9/00

(52) U.S. Cl. 382/128

(57) ABSTRACT

An image processing device includes an acquiring unit, an identification unit, a generating unit, an accepting unit, a preparing unit, and a control unit. The acquiring unit acquires image information that expresses plural radiation images. The identification unit identifies lesions. The generating unit generates three-dimensional information expressing positions of the lesions in a three-dimensional space. The accepting unit accepts a designation of an observation direction. The preparing unit prepares a first image for a right eye and a second image for a left eye. The first and second images are at a predetermined parallax angle when observing the lesions from the observation direction. The control unit controls an image display unit that displays the first image for the right eye and the second image for the left eye.

### CROSS-REFERENCE TO RELATED APPLICATION

This application claims priority under 35 USC 119 from Japanese Patent Application No. 2009-035380 filed on Feb. 18, 2009, the disclosure of which is incorporated by reference herein.

### BACKGROUND OF THE INVENTION

1. Field of the Invention

The present invention relates to an image processing device, an image processing system and a computer readable medium on which is recorded an image processing program. In particular, the present invention relates to an image processing device, an image processing system and a computer readable medium on which is recorded an image processing program, that reconstruct captured radiation images and prepare a stereo image.

2. Description of the Related Art

Radiation imaging devices that carry out radiation imaging for the purpose of medical diagnosis are known conventionally. An example of this type of radiation imaging device is a mammography machine that image-captures a breast of a subject for the purpose of, for example, early detection of breast cancer or the like.

Because a radiation image obtained by imaging by a radiation image device is a two-dimensional image, the three-dimensional distribution of lesions and the like is difficult to judge.

A stereo imaging method is proposed as a technique that improves diagnostic accuracy.

For example, Japanese Patent Application Laid-Open (JP-A) No. 64-2628 discloses a technique in which a stereo image is acquired by irradiating X-rays onto a subject from two different directions. Three-dimensional information is determined by determining information of the depth direction from the acquired stereo image. Coordinate rotating processing relating to three orthogonal axes is carried out on the three-dimensional information, and pseudo-three-dimensional display is carried out on a display section.

JP-A No. 9-114979 discloses a technique in which a subject is captured by two or more imaging units from different positions, and three-dimensional information of the subject within the captured images is detected. A virtual captured image in a plane seen from an arbitrary viewpoint is generated on the basis of the detected three-dimensional information.

U.S. Pat. No. 7,142,633 discloses a technique in which X-rays are continuous-pulse-irradiated at different angles onto an examined region in the image capturing of a single time, and three-dimensional information is reconstructed from the numerous images that are captured from the numerous directions.

JP-A No. 2003-245274 discloses a technique in which a subject is captured from a front direction, and is captured respectively from directions of a predetermined angle to the left and the right with respect to the front direction. The radiation image that is captured from the front direction, and the radiation images that are captured from the directions of the predetermined angle to the left and the right, are switchingly displayed on a display device. In this display device, the polarization directions of the display lights are orthogonal at odd-numbered lines and even-numbered lines. By viewing the images while wearing polarizing glasses that make the polarization directions at the right lens and the left lens orthogonal, the odd-numbered lines and the even-numbered lines can be seen separately by the right eye and the left eye. When displaying the radiation image that is captured from the front direction, the same image is displayed at the odd-numbered lines and the even-numbered lines. When displaying the radiation images that are captured from the directions of the predetermined angle to the left and the right, the left and right separate images are displayed at the odd-numbered lines and the even-numbered lines.

In order to determine three-dimensional information, plural (e.g., two) radiation images must be captured, and corresponding points between the captured images must be determined.

However, in the techniques disclosed in JP-A Nos. 64-2628 and 9-114979, various images are included within the respective captured images. Therefore, there are cases in which corresponding points between the images cannot be found and cases in which erroneous corresponding points are found, and three-dimensional information cannot be generated appropriately.

If numerous (around 10 to 20) radiation images are captured from numerous directions and corresponding points among the captured numerous images are determined as in U.S. Pat. No. 7,142,633, all of the voxel information in a three-dimensional space can be obtained, and therefore, three-dimensional information can be generated appropriately. However, the number of radiation images that are captured is large, and the amount of radiation that the subject is exposed to also increases.

In the technique disclosed in JP-A No. 2003-245274, radiation images captured from directions of a predetermined angle to the left and the right are displayed separately at the odd-numbered lines and the even-numbered lines of a display device. The distribution of lesions can thereby be viewed in three dimensions. However, the lesions can only be viewed from the capturing direction.

### SUMMARY OF THE INVENTION

The present invention has been made in view of the above circumstances and provides an image processing device, an image processing system and a computer readable medium on which is recorded an image processing program.

According to an aspect of the invention, there is provided an image processing device including: an acquiring unit that acquires image information, the image information expressing a plurality of radiation images that are captured by radiations being irradiated from different positions from radiation sources onto a region of a subject that is an object of imaging; an identification unit that identifies lesions that are objects of observation within each of the plurality of radiation images that are expressed by the image information acquired by the acquiring unit; a generating unit that determines correspondence relationships of the lesions identified by the identification unit, and, based on positional relationships of corresponding lesions within the plurality of radiation images and based on positional relationships of the radiation sources at a time of capturing the plurality of radiation images, generates three-dimensional information that expresses positions of the lesions in a three-dimensional space; an accepting unit that accepts a designation of an observation direction in which the lesions are to be observed within the three-dimensional space; a preparing unit that, based on the three-dimensional information, prepares a first image for a right eye and a second image for a left eye, wherein the first and second images are at a predetermined parallax angle when observing the lesions from the observation direction accepted at the accepting unit; and a control unit that controls an image display unit that displays the first image for the right eye and the second image for the left eye that are prepared by the preparing unit.

### BRIEF DESCRIPTION OF THE DRAWINGS

Preferred embodiments of the present invention will be described in detail based on the following figures, wherein:

FIG. 1 is a plan view showing the structure of an imaging device relating to an exemplary embodiment;

FIG. 2 is a perspective view showing the structure at the time of CC imaging of the imaging device relating to the exemplary embodiment;

FIG. 3 is a perspective view showing the structure at the time of MLO imaging of the imaging device relating to the exemplary embodiment;

FIG. 4 is a block diagram showing the structure of a radiation imaging system relating to the exemplary embodiment;

FIG. 5 is a perspective view showing the structure of a stereo display device relating to the exemplary embodiment;

FIG. 6 is a drawing showing a case of stereoscopically viewing an image of the stereo display device relating to the exemplary embodiment;

FIG. 7 is a drawing showing the positional relationships between a radiation irradiating section and an imaging stand at a time of image capturing, relating to the exemplary embodiment;

FIG. 8 is a flowchart showing the flow of processings of a three-dimensional image generating processing program relating to the exemplary embodiment;

FIG. 9 is a drawing showing the relationships between calcified portions within a breast and calcified regions of radiation images, relating to the present exemplary embodiment;

FIG. 10 is a flowchart showing the flow of processings of a stereo image preparing processing program relating to the exemplary embodiment;

FIG. 11 is an explanatory drawing for explaining changes in a parallax angle at the time of enlargement, relating to the exemplary embodiment; and

FIG. 12 is a drawing showing the relationships between three-dimensional positions of calcified portions, and images for the right eye and images for the left eye, relating to the exemplary embodiment.

### DETAILED DESCRIPTION OF THE INVENTION

The present invention provides an image processing device, an image processing system and a computer readable medium on which is recorded an image processing program that can observe, in a stereoscopic view, lesions that are objects of observation, from various directions while suppressing the amount of radiation to which a subject is exposed.

Hereinafter, a case will be described, with reference to the drawings, in which the present invention is applied to a radiation imaging system that captures radiation images, reconstructs the captured radiation images, and carries out stereo display.

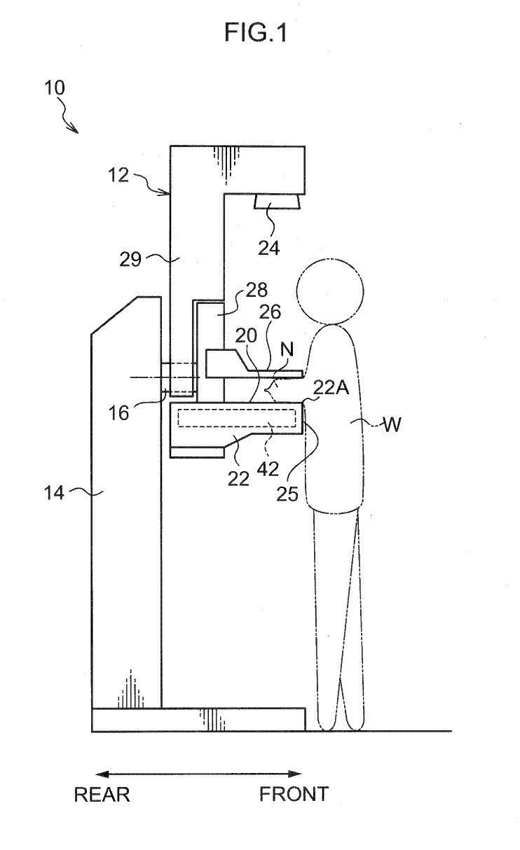

A radiation imaging device 10 that captures radiation images will be described with reference to FIG. 1 through FIG. 3.

The radiation imaging device 10 relating to the present exemplary embodiment is a device that image-captures, by radiation (e.g., X-rays), a breast N of a subject W in an erect state in which the subject is standing, and is called, for example, a mammography machine. Hereinafter, description will be given with the near side that is close to the subject W when the subject W is facing the radiation imaging device 10 at the time of image capturing being called the device front side of the radiation imaging device 10, the deep side that is far from the subject W when the subject W is facing the radiation imaging device 10 being called the device rear side, and the left and right directions of the subject W when the subject W is facing the radiation imaging device 10 being called the device left and right directions of the radiation imaging device 10 (refer to the arrow in FIG. 1).

The object of imaging at the radiation imaging device 10 is not limited to the breast N, and may be, for example, another region of the body, or an object. The radiation imaging device 10 may be a device that image-captures the breast N of a subject in a seated state who is seated on a chair or the like. It suffices for the radiation imaging device 10 to be a device that image-captures the breast N of the subject W with at least the upper half of the body of the subject W being in an erect state.

As shown in FIG. 1, the radiation imaging device 10 has a measuring section 12 that is substantially shaped as the letter C (the letter U) in side view and that is provided at the device front side, and a base portion 14 that supports the measuring section 12 from the device rear side.

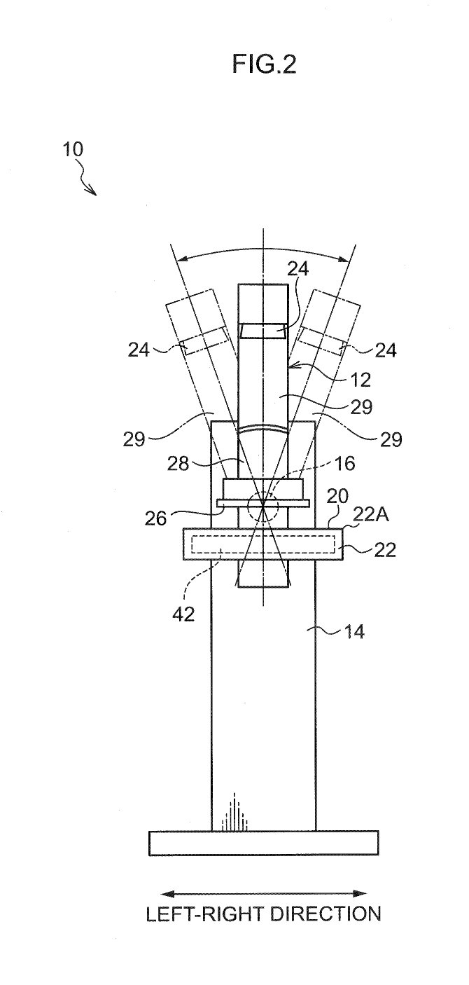

As shown in FIG. 1 and FIG. 2, the measuring section 12 has an imaging stand 22 at which is formed an imaging surface 20 that is planar and that the breast N of the subject W who is in an erect state contacts, a compression plate 26 that pushes the breast N against the imaging surface 20, and a holding section 28 that holds the imaging stand 22 and the compression plate 26.

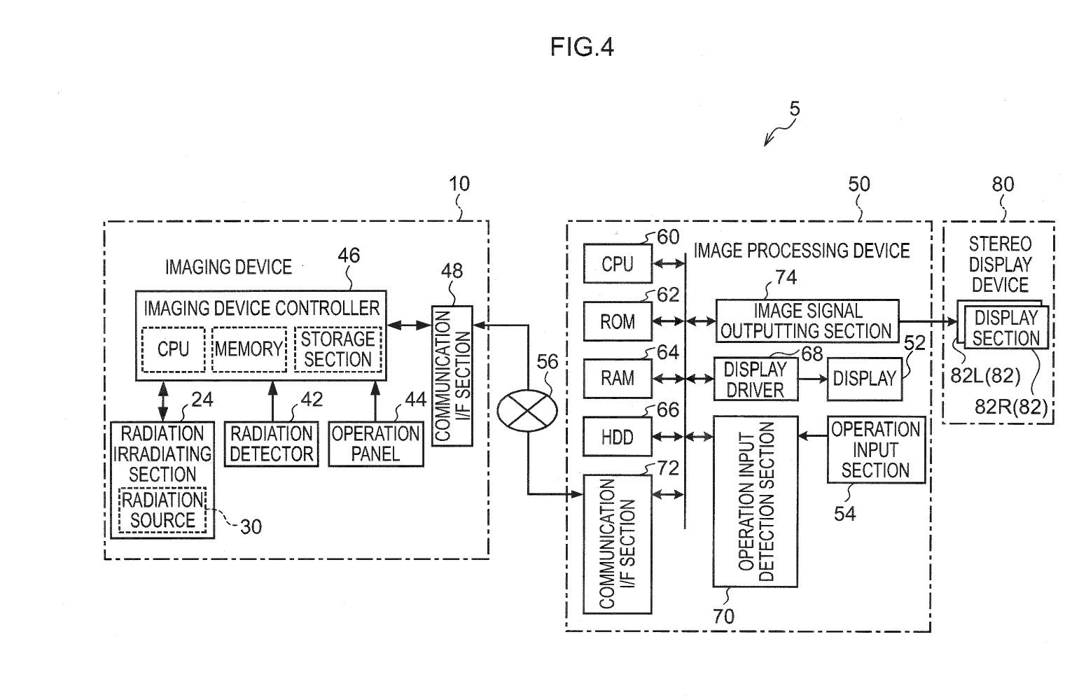

The measuring section 12 has a radiation irradiating section 24 that is provided with a radiation source 30 (see FIG. 4) such as a light tube or the like and that irradiates radiation for examination from the radiation source 30 toward the imaging surface 20, and a supporting section 29 that is separate from the holding section 28 and supports the radiation irradiating section 24.

A rotating shaft 16 that is rotatably supported at the base section 14 is provided at the measuring section 12. The rotating shaft 16 is fixed to the supporting section 29, and the rotating shaft 16 and the supporting section 29 rotate integrally.

The holding section 28 can be switched between a state in which the rotating shaft 16 is connected to the holding section 28 and rotates integrally therewith, and a state in which the rotating shaft 16 is separated from the holding section 28 and rotates idly. Concretely, gears are provided respectively at the rotating shaft 16 and the holding section 28, and the state is switched between a state in which the gears are meshed-together and a state in which the gears are not meshed-together.

Any of various mechanical elements can be used for the switching between transmission/non-transmission of the rotational force of the rotating shaft 16.

The holding section 28 holds the imaging stand 22 and the radiation irradiating section 24 such that the imaging surface 20 and the radiation irradiating section 24 are separated by a predetermined interval. Further, the holding section 28 slidably holds the compression plate 26 such that the interval between the compression plate 26 and the imaging surface 20 can be varied.

From the standpoints of the radiation transmitting property and strength, the imaging surface 20 that the breast N abuts is formed of carbon for example. A radiation detector 42, on which the radiation that has passed-through the breast N and the imaging surface 20 is irradiated and that detects this radiation, is disposed at the interior of the imaging stand 22. The radiation that the radiation detector 42 detects is made visible, and a radiation image is generated.

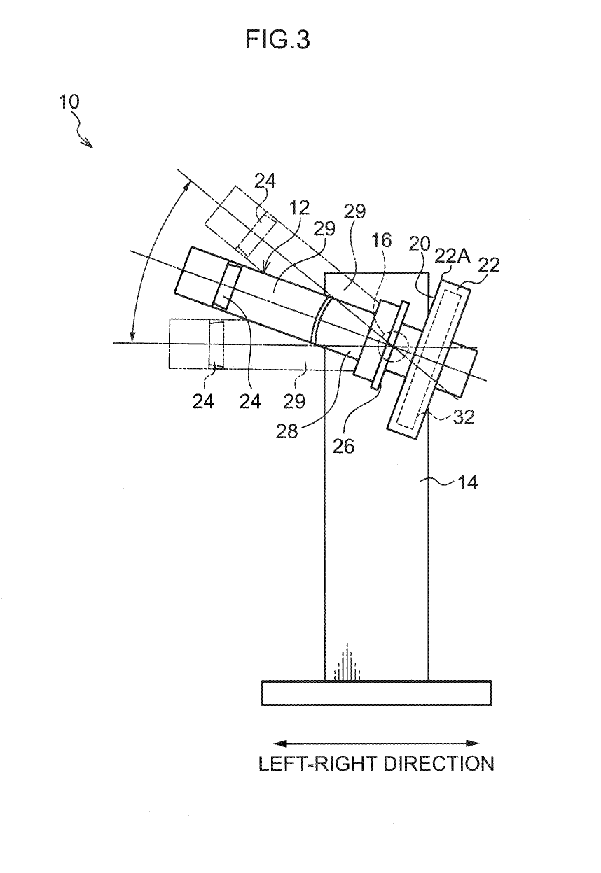

The radiation imaging device 10 relating to the present exemplary embodiment is a device that can carry out at least both of CC imaging (imaging in the cranial-caudal direction) and MLO imaging (imaging in the mediolateral oblique direction) of the breast N. FIG. 1 and FIG. 2 show the posture of the radiation imaging device 10 at the time of CC imaging, and FIG. 3 shows the posture of the radiation imaging device 10 at the time of MLO imaging of the imaging device.

As shown in FIG. 1, at the time of CC imaging, the posture of the holding section 28 is adjusted to a state in which the imaging surface 20 faces upward, and the posture of the supporting section 29 is adjusted to a state in which the radiation irradiating section 24 is positioned upward of the imaging surface 20. Due thereto, radiation is irradiated from the radiation irradiating section 24 onto the breast N from the head side toward the leg side of the subject W who is in an erect state, and CC imaging (imaging in the cranial-caudal direction) is carried out.

A chest wall surface 25, that is made to abut the chest region that is beneath the breast N of the subject W at the time of CC imaging, is formed at the device front side surface of the imaging stand 22. The chest wall surface 25 is planar.

At the time of MLO imaging, as shown in FIG. 3, generally, the posture of the holding section 28 is adjusted to a state in which the imaging stand 22 is rotated by greater than or equal to 45° and less than 90° as compared with at the time of CC imaging, and is positioned such that the armpit of the subject W abuts a side wall corner portion 22A at the device front side of the imaging stand 22. Due thereto, radiation is irradiated from the radiation irradiating section 24 toward the breast N from the axially central side toward the outer side of the torso of the subject W, and MLO imaging (imaging in the mediolateral oblique direction) is carried out.

At the radiation irradiating device 10, as shown in FIG. 2, when carrying out stereo image capturing, the rotating shaft 16 rotates idly with respect to the holding section 28 and the imaging stand 22 and the compression plate 26 do not move, and, due to the supporting section 29 rotating, only the radiation irradiating section 24 moves in the form of an arc.

By rotating only the radiation irradiating section 24 in this way, the radiation irradiating section 24 can be positioned at plural positions having parallax.

Due thereto, stereoscopic viewing of an image is possible due to one of plural images, that are captured at the plural positions having parallax, being visually recognized by the right eye and the other being visually recognized by the left eye.

A block diagram showing the detailed structure of a radiation imaging system 5 relating to the present exemplary embodiment is shown in FIG. 4.

The radiation imaging system 5 has the above-described radiation imaging device 10, an image processing device 50 that carries out reconstruction of captured radiation images, and a stereo display device 80 that carries out stereo display of the reconstructed image. Note that the stereo display device 80 corresponds to the image display unit.

The radiation imaging device 10 further has the radiation detector 42, an operation panel 44 to which are inputted various types of operation information such as exposure conditions, posture information and the like, and various types of operation instructions, an imaging device controller 46 controlling the operation of the entire device, and a communication I/F section 48 connected to a network 56 such as a LAN or the like and transmitting and receiving various types of information to and from other devices that are connected to the network 56.

The imaging device controller 46 has a CPU, memories including a ROM and a RAM, and a non-volatile storage formed from an HDD or a flash memory or the like. The imaging device controller 46 is connected to the radiation irradiating section 24, the radiation detector 42, the operation panel 44, and the communication I/F section 48.

The exposure conditions designated at the operation panel 44 include information such as tube voltage, tube current, irradiation time period, and the like. The posture information includes information expressing whether the image capturing posture is CC imaging or MLO imaging. These various types of operation information, such as exposure conditions, posture conditions and the like, and various types of operation instructions may be obtained from another control device.

If the image capturing posture specified by the posture information is CC imaging, the imaging device controller 46 adjusts the posture of the holding section 28 to a state in which the imaging surface 20 faces upward, and adjusts the posture of the supporting section 29 to a state in which the radiation irradiating section 24 is positioned upwardly of the imaging surface 20. If the image capturing posture specified by the posture information is MLO imaging, the imaging device controller 46 adjusts the posture of the holding section 28 to a state in which the imaging stand 22 is rotated by greater than or equal to 45° and less than 90°, and adjusts the posture of the supporting section 29 to a state in which the radiation irradiating section 24 is positioned upwardly of the imaging surface 20. The imaging device controller 46 rotates the supporting section 29 and moves the radiation irradiating section 24 in the form of an arc, and, on the basis of the exposure conditions, causes the radiation X to be irradiated individually at different angles with respect to the imaging surface 20 from the radiation source 30 provided at the radiation irradiating section 24.

The radiation detector 42 receives the irradiation of the radiation that carries the image information, and records the image information, and outputs the recorded image information. For example, the radiation detector 42 is structured as an FPD (Flat Panel Detector) in which a radiation sensitive layer is disposed and that converts radiation into digital data and outputs the digital data. When radiation is irradiated, the radiation detector 42 outputs the image information, that expresses the irradiated radiation image, to the imaging device controller 46.

The imaging device controller 46 can communicate with the image processing device 50 via the communication I/F section 48, and carries out transmission and reception of various types of information to and from the image processing device 50.

The image processing device 50 is structured as a server computer, and has a display 52 that displays operation menus, various types of information and the like, and an operation input section 54 that is structured to include plural keys and by which various types of information and operation instructions are inputted. Note that the operation input section 54 corresponds to the accepting unit.

The image processing device 50 is structured to include: a CPU 60 that governs operations of the entire device; a ROM 62 in which various types of programs including control programs, and the like, are stored in advance; a RAM 64 that temporarily stores various types of data; an HDD 66 that stores and holds various types of data; a display driver 68 controlling the display of various types of information onto the display 52; an operation input detection section 70 that detects the operated state of the operation input section 54; a communication I/F section 72 that is connected to the radiation imaging device 10 via the network 56 and that carries out transmission and reception of various types of information to and from the radiation imaging device 10; and an image signal outputting section 74 that outputs image signals to the stereo display device 80 via a display cable 58. Note that the CPU 60 corresponds to the identification unit, the generating unit, the preparing unit, and the control unit. Further, the HDD 66 corresponds to the storage unit.

The CPU 60, the ROM 62, the RAM 64, the HDD 66, the display driver 68, the operation input detection section 70, the communication I/F section 72 and the image signal outputting section 74 are connected to one another via a system bus BUS. Accordingly, the CPU 60 can access the ROM 62, the RAM 64 and the HDD 66. The CPU 60 can carry out control of display of various types of information onto the display 52 via the display driver 68, and control of the transmission and reception of various types of information to and from the radiation imaging device 10 via the communication I/F section 72, and control of the image displayed on the stereo display device 80 via the image signal outputting section 74. Further, the CPU 60 can, via the operation input detection section 70, grasp the state of operation of the operation input section 54 by the user. Note that the communication I/F section 72 corresponds to the acquiring unit.

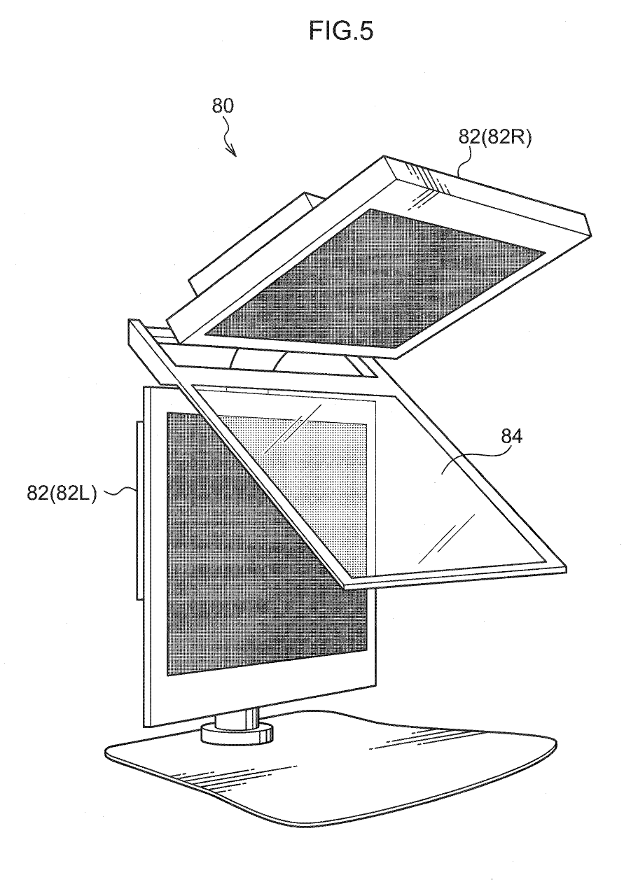

An example of the structure of the stereo display device 80 relating to the present exemplary embodiment is shown in FIG. 5.

As shown in FIG. 5, at the stereo display device 80, two display sections 82 are disposed so as to be lined-up vertically. One of the display sections 82 is fixed to the upper side of the stereo display device 80 so as to be inclined forward. The polarization directions of the display lights of the two display sections 82 are orthogonal. The display section 82 at the upper side is a display section 82R that displays an image for the right eye, and the display section 82 at the lower side is a display section 82L that displays an image for the left eye. A beam splitter mirror 84, that transmits the display light from the display section 82L and reflects the display light from the display section 82R, is provided between the display sections 82L, 82R. The beam splitter mirror 84 is fixed with the angle thereof adjusted such that, when an observer looks at the stereo display device 80 from the front, the image displayed at the display section 82L and the image displayed at the display section 82R overlap.

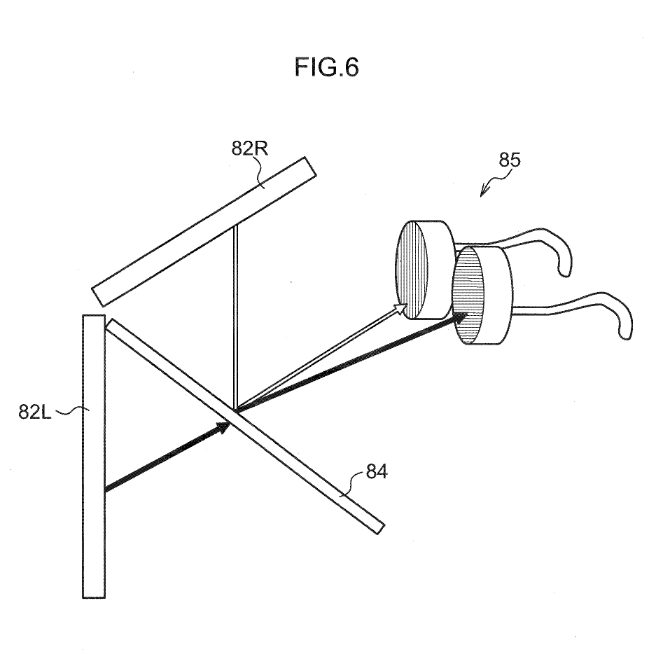

Due to the observer looking at the stereo display device 80 while wearing polarizing glasses 85 at which the polarization directions are orthogonal at the right lens and at the left lens as shown in FIG. 6, the image displayed on the display section 82L and the image displayed on the display section 82R can be seen separately by the right eye and the left eye.

Operation of the radiation imaging system 5 relating to the present exemplary embodiment will be described.

When stereo imaging of radiation images is to be carried out, the exposure conditions and posture information are inputted to the operation panel 44 of the radiation imaging device 10.

If the imaging posture designated by the posture information is CC imaging, as shown in FIG. 2, the radiation imaging device 10 adjusts the posture of the holding section 28 to a state in which the imaging surface 20 is directed upward, and adjusts the posture of the supporting section 29 to a state in which the radiation irradiating section 24 is positioned upwardly of the imaging surface 20. If the imaging posture designated by the posture information is MLO imaging, as shown in FIG. 3, the radiation imaging device 10 adjusts the posture of the holding section 28 to a state in which the imaging stand 22 is rotated by greater than or equal to 45° and less than 90°, and adjusts the posture of the supporting section 29 to a state in which the radiation irradiating section 24 is positioned upwardly of the imaging surface 20.

The subject W causes the breast N to abut the imaging surface 20 of the radiation imaging device 10. At the radiation imaging device 10, when an operation instruction to start compression is given at the operation panel 44 in this state, the compression plate 26 moves toward the imaging surface 20. The compression plate 26 abuts the breast N and presses it further. When the pressing force of the compression plate 26 reaches the set pressing force, movement of the compression plate 26 is stopped by the control of the imaging device controller 46.

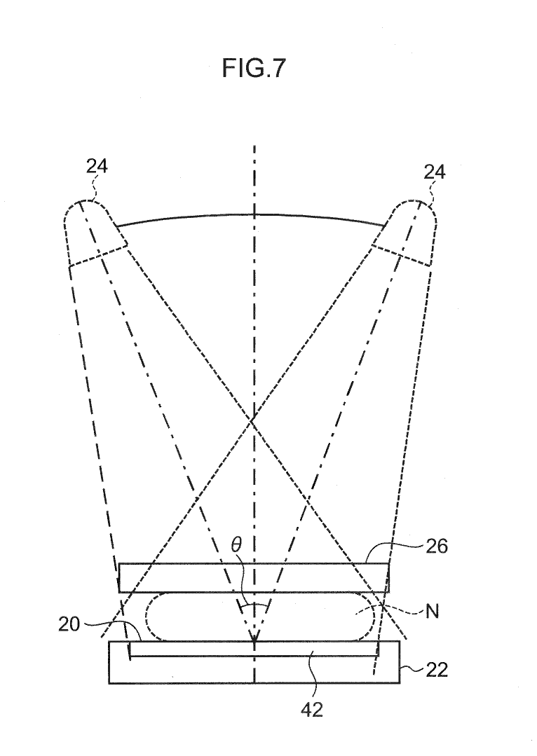

At the radiation imaging device 10 relating to the present exemplary embodiment, when an exposure start operation instruction is carried out at the operation panel 44 in this state, as shown in FIG. 2 and FIG. 3, only the supporting section 29 is rotated and the radiation irradiating section 24 is moved in the form of an arc, and, as shown in FIG. 7, irradiates radiation individually from the radiation source 30 of the radiation irradiating section 24 at a predetermined angle θ (e.g., 10°) that is formed with respect to the imaging surface 20. This formed angle θ may be a fixed value, or, for example, may be changed in accordance with the region that is the object of imaging or the lesion to be observed, or the thickness of the region that is the object of imaging, or the like. The radiations that are irradiated individually from the radiation irradiating section 24 respectively reach the radiation detector 42 after having been transmitted through the breast N.

When the radiations are irradiated, the radiation detector 42 outputs, to imaging device controller 46, respective image information expressing the irradiated radiation images.

The imaging device controller 46 associates the image information, that express the two captured radiation images, and the exposure conditions at the times of capturing the radiation images, and transmits them to the image processing device 50 by communication.

By receiving the image information and the exposure conditions at the communication I/F section 72, the image processing device 50 acquires the respective image information that express the two captured radiation images. The image processing device 50 carries out various image correction processings, such as shading correction and the like, on the respective image information that are received. The image processing device 50 associates the two radiation images after correction with the exposure conditions and the like, and stores them in the HDD 66 as imaging information obtained by image capturing of a single time.

Thereafter, on the basis of the two radiation images that are stored as imaging information of a single time in the HDD 66, the image processing device 50 carries out three-dimensional image generating processing that generates three-dimensional information.

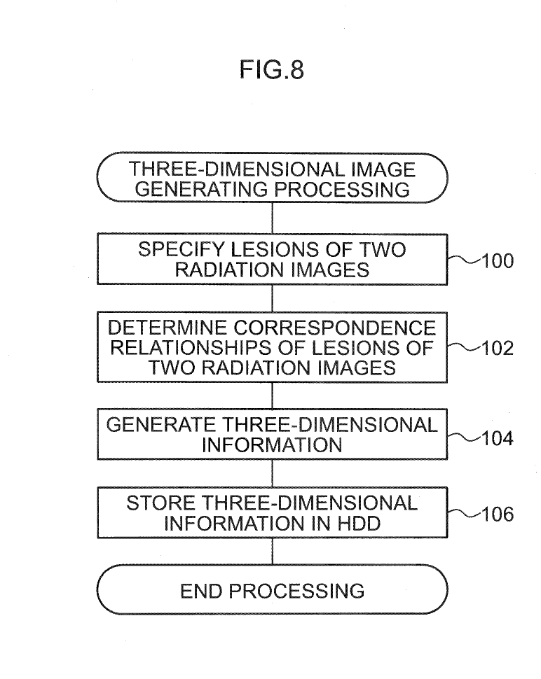

A flowchart showing the flow of processings of the three-dimensional image generating processing program, that is executed by the CPU 60 and relates to the present exemplary embodiment, is shown in FIG. 8. This program is stored in advance in a predetermined area of the ROM 62.

In step 100 of FIG. 8, minute calcified clusters are identified as lesions from each of the two radiation images that are stored as imaging information of a single time. In the present exemplary embodiment, calcified regions within the images are identified by CAD (computer aided detection).

In a general radiation image of a breast, a calcified region has a higher luminance (lower density) than the background, and presents a small, pointed, pulse-shaped shadow.

In the CAD relating to the present exemplary embodiment, by carrying out differential processing on the radiation images, regions whose differential values and luminances are high are detected as calcified regions. When detecting calcified regions with even higher accuracy, for example, morphological processing that utilizes morphological computation may be carried out.

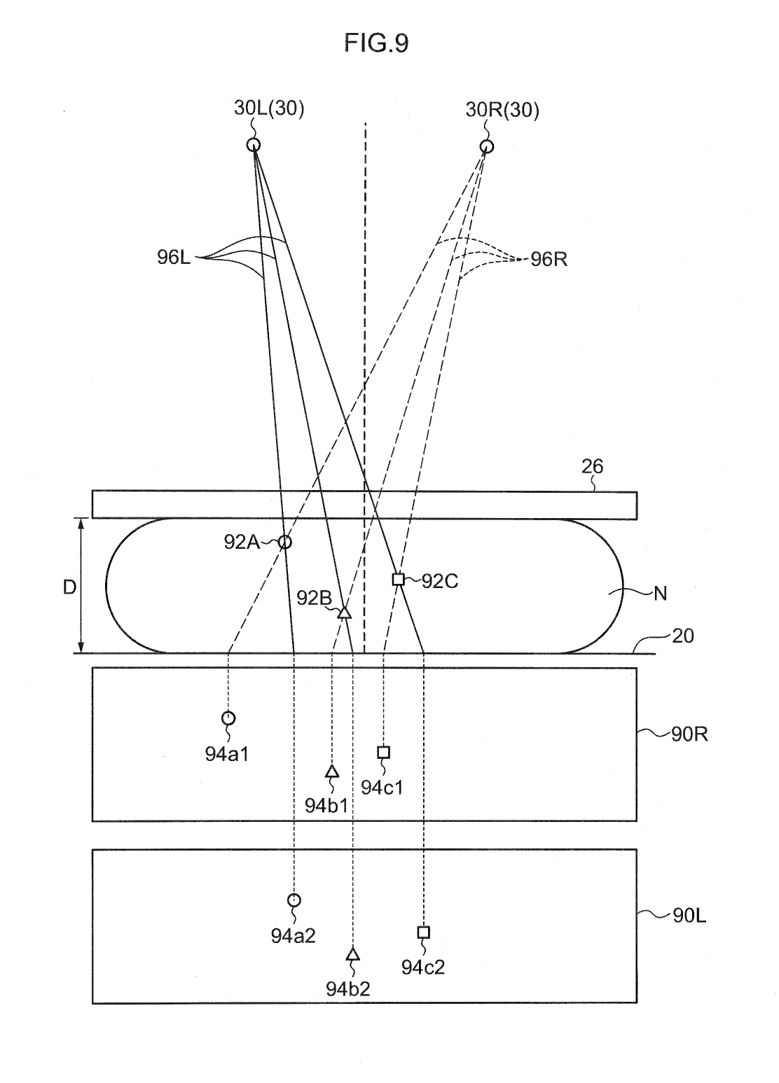

An example of the results of identifying calcified regions of two radiation images 90L, 90R is schematically shown in FIG. 9. The circular mark, triangular mark and square mark within the breast N in FIG. 9 represent calcified portions 92A through 92C, respectively. The circular marks, triangular marks, and square marks within the radiation images 90L, 90R represent calcified regions 94a1 through 94c1, 94a2 through 94c2, that are recorded in correspondence with the calcified portions 92A through 92C within the breast N, respectively. Hereinafter, when referring to the calcified portions 92A through 92C within the breast N without differentiating therebetween, they are simply called the calcified portions 92. When referring to the calcified regions 94a1 through 94c1, 94a2 through 94c2 within the radiation images 90L, 90R without differentiating therebetween, they are simply called the calcified regions 94.

In step 102, correspondence relationships of the calcified regions 94a1 through 94c1 of the radiation image 90R and the calcified regions 94a2 through 94c2 of the radiation image 90L are determined.

As shown in FIG. 9, the positions of the calcified regions 94 recorded in the radiation images 90L, 90R differ in accordance with the three-dimensional positions of the calcified portions 92 within the breast N. In mammography, because depth D of the breast N is determined with the breast N being pressed by the compression plate 26, the ranges in which the calcified regions 94 are recorded in the radiation images 90L, 90R in correspondence with a same calcified portion 92 within the breast N, are prescribed. Accordingly, the calcified regions 94, that are recorded in the radiation images 90L, 90R and that correspond to the same calcified portion 92 within the breast N, can be determined, for example, by setting the position at which the calcified region 94 of one radiation image among the radiation images 90L, 90R exists as a reference position, and searching by matching within a range, that is prescribed in accordance with the depth D from that reference position of the other radiation image. Due thereto, in FIG. 9, it is determined that the calcified regions 94a1 and 94a2 correspond, and that the calcified regions 94b 1 and 94b2 correspond, and that the calcified regions 94c1 and 94c2 correspond.

In order to accurately determine the correspondence relationships, for example, a calcified region of one radiation image may be searched for within the other radiation image, and a calcified region of the other radiation image may be searched for within the one radiation image, and calcified regions that correspond in the both may be found. Further, corresponding calcified regions may be found by including positional relationships of peripheral calcified regions.

In step 104, for each of the corresponding calcified regions 94 of the radiation images 90L, 90R, on the basis of the positional relationships of the corresponding calcified regions 94 within the radiation images 90L, 90R and the positional relationships of the radiation source 30 at the times of capturing the respective radiation images 90L, 90R, three-dimensional information is generated that expresses the position, in a three-dimensional space, of the calcified portion 92 within the breast N. In FIG. 9, the positions of the radiation source 30 at the times of capturing the radiation images 90L, 90R respectively, are shown as radiation source 30L, 30R.

In the present exemplary embodiment, for each of the corresponding calcified regions 94 of the radiation images 90L, 90R, a straight line 96L, that connects the radiation source 30L and the calcified region 94 of the radiation image 90L, and a straight line 96R, that connects the radiation source 30R and the calcified region 94 of the radiation image 90R, are determined. The position where the straight line 96L and the straight line 96R intersect is identified, and three-dimensional information is generated by using the identified position as a position within a three-dimensional space of the calcified portion 92.

In step 106, the generated three-dimensional information is stored in the HDD 66, and processing ends.

Three-dimensional information is thereby stored in the HDD 66.

The image processing device 50 can cause the stereo display device 80 to display a stereo image showing the calcified portions 92 within a three-dimensional space, on the basis of the three-dimensional information stored in the HDD 66. When a predetermined operation instruction to start stereo image display is carried out with respect to the operation input section 54, the image processing device 50 carries out stereo image preparing (creating) processing that prepares (creates) an image for the right eye and an image for the left eye that can be seen in stereo, and displays the stereo image on the stereo display device 80. When a stereo image is to be displayed, the image processing device 50 accepts, at the operation input section 54, a designation of the observation direction in which the calcified portion 92 is to be observed in the three-dimensional space, and a designation of the enlargement rate for enlarging the image.

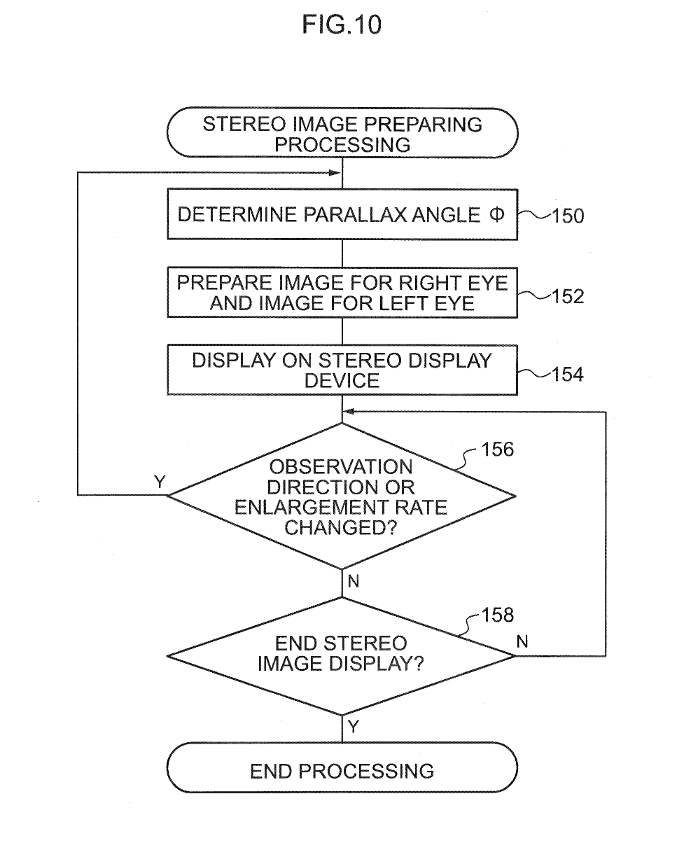

A flowchart showing the flow of processings of a stereo image preparing processing program, that is executed by the CPU 60 and relates to the present exemplary embodiment, is shown in FIG. 10. This program is stored in advance in a predetermined area of the ROM 62.

In step 150 of FIG. 10, a parallax angle φ at the time of preparing the image for the right eye and the image for the left eye is determined.

The image processing device 50 relating to the present exemplary embodiment can display the stereo image in an enlarged manner. However, when displaying a stereo image in an enlarged manner, there are cases in which the depth is emphasized and the observer cannot see in stereo.

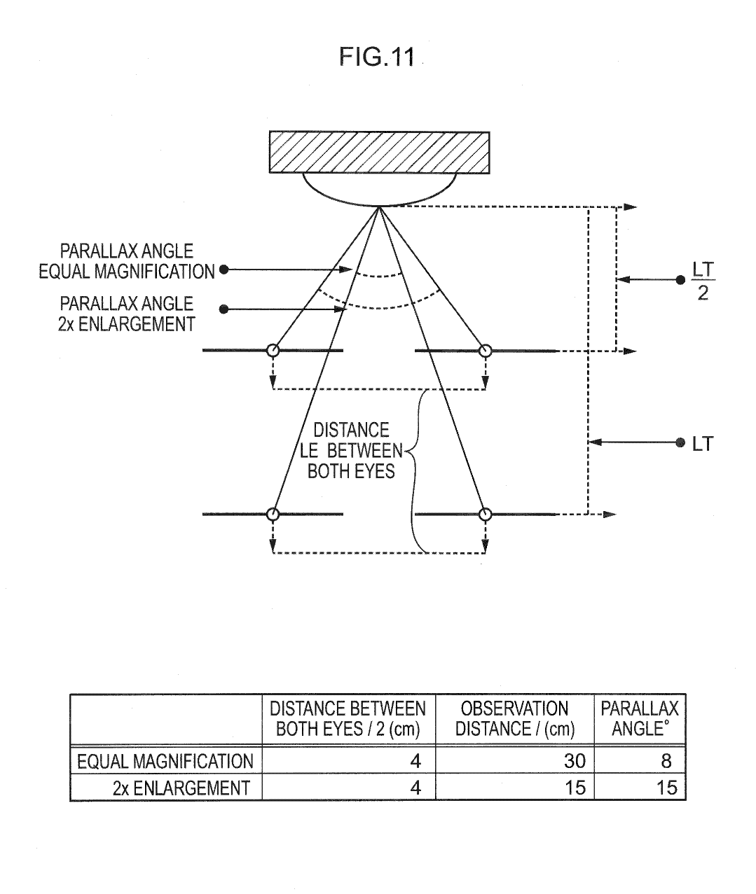

For example, as shown in FIG. 11, if a distance LE between the right eye and the left eye is 8 cm and an observation distance LT at equal magnification is 30 cm, the parallax angle at equal magnification is 8°. However, the parallax angle at 2× with the observation distance LT being ½ is 15°, and the observer cannot see in stereo.

In the present exemplary embodiment, the greater the enlargement rate, the smaller the parallax angle φ is made as compared to actuality, and the image is displayed at a depth that is nearer to the actual space. Due thereto, for example, when using a stereo image in a simulation that supposes a surgery, the simulation can be carried out at a depth that is near to the actual space.

In the present exemplary embodiment, when equal magnification is designated (the enlargement rate is 1×), the parallax angle is computed from an enlargement rate that is designated with the parallax angle φ being 8°. However, if the computed parallax angle is greater than or equal to a given value (e.g., 10°), a projected image for the right eye and a projected image for the left eye are prepared with the parallax angle being made smaller than the computed parallax angle. For example, when a magnification of 2× is designated, the parallax angle φ is determined such that the parallax angle φ is made smaller than in actuality, and the parallax angle φ becomes 10°.

In step 152, an image for the right eye and an image for the left eye are prepared on the basis of the three-dimensional information stored in the HDD 66.

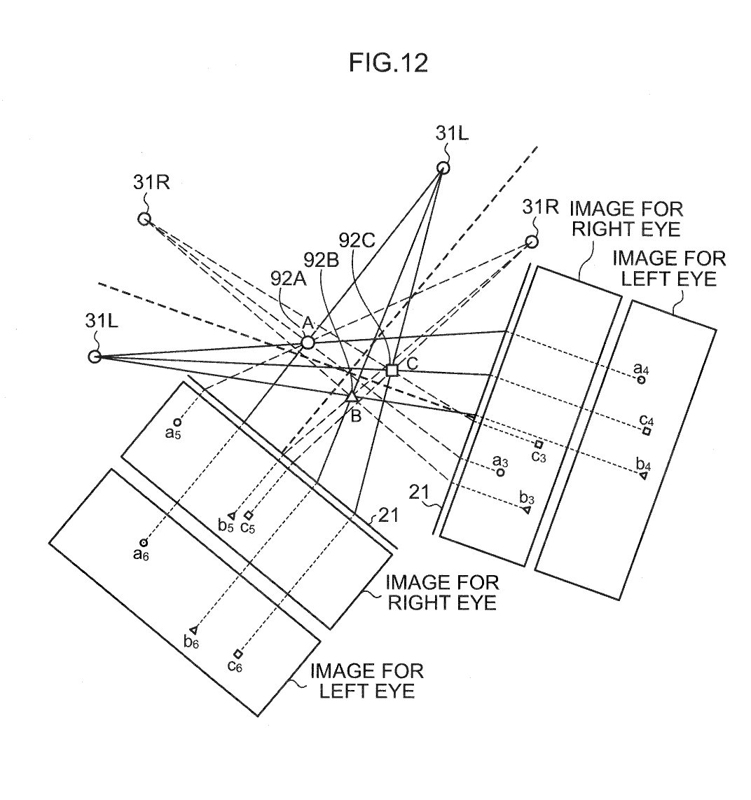

The flow of the preparing of the image for the right eye and the image for the left eye is shown schematically in FIG. 12. Note that FIG. 12 shows a case in which the image for the right eye and the image for the left eye are respectively prepared from two observation directions.

As shown in FIG. 12, the three-dimensional positions of the calcified portions 92 (92A, 92B, 92C) are stored in the three-dimensional information.

In the present exemplary embodiment, the image for the right eye and the image for the left eye are prepared with a virtual imaging surface 21 being perpendicular to the observation direction, and with the respective calcified portions 92 being projected onto the imaging surface 21 from two viewpoints 31L, 31R of the parallax angle φ with respect to the imaging surface 21.

Enlarging of the image can be carried out by setting the virtual imaging surface 21 farther away from the viewpoints 31L, 31R, or by setting the entire three-dimensional region, that includes the calcified portions 92 shown by the three-dimensional information, closer to the viewpoints 31L, 31R. In the present exemplary embodiment, enlarging of the image is carried out by, given that the observation distance at equal magnification is LT, making the observation distance be a value equal to LT divided by the enlargement rate.

In step 154, the prepared image for the right eye is displayed on the display section 82R, and the prepared image for the left eye is displayed on the display section 82L.

Due thereto, an observer such as a doctor or the like can read the radiation image and carry out diagnosis or the like. Due to the observer viewing the stereo display device 80 while wearing the polarizing glasses 85, the distribution of the calcified portions 92 can be viewed in three dimensions.

In step 156, it is judged whether or not changing of the observation direction or enlargement rate has been instructed at the operation input section 54. If the judgment is affirmative, the routine moves on to step 150. If the judgment is negative, the routine proceeds to step 158.

Due thereto, when the observer changes the observation direction and/or the enlargement rate, a stereo image at the changed observation direction and/or with the enlargement rate is displayed at the stereo display device 80.

In step 158, it is judged whether or not an operation instruction to end stereo image display has been carried out at the operation input section 54. If the judgment is affirmative, processing ends. If the judgment is negative, the routine moves on to step 156.

As described above, in accordance with the present exemplary embodiment, the calcified regions 94 are identified from the two radiation images 90L, 90R respectively, correspondence relationships of the identified calcified regions 94 are determined, and three-dimensional information expressing the positions in a three-dimensional space of the calcified regions 94 are generated on the basis of the positional relationships within the radiation images 90L, 90R of the corresponding calcified regions 94 and the positional relationships of the radiation source 30L, 30R at the times of capturing the radiation images 90L, 90R. Therefore, three-dimensional information relating to the calcified regions 94 can be generated appropriately with a small amount of radiation that the subject is exposed to.

In accordance with the present exemplary embodiment, an image for the right eye and an image for the left eye of a predetermined parallax angle when observing the calcified regions 94 from an observation direction that is accepted at the operation input section 54, are prepared on the basis of the three-dimensional information. Control is carried out such that the prepared image for the right eye and the prepared image for the left eye are respectively displayed on the stereo display device 80. Therefore, the calcified regions 94 can be observed in a stereoscopic view from various directions.

Because the calcified regions within the radiation images are small, identification of a calcified region as a point of a predetermined position of the calcified region (e.g., the center of gravity or the center) may be carried out.

In this case, various types of image processings such as morphing, deformation, rotation, interpolation, and the like may be carried out on partial images of predetermined regions that include calcified regions of the two radiation images, and a partial image for the right eye and a partial image for the left eye, in which the partial images are observed from the observation direction, may be further prepared. The prepared partial image for the right eye and the prepared partial image for the left eye may respectively be displayed at the positions of the calcified regions of the image for the right eye and the image for the left eye.

Images for the right eye and images for the left eye of a predetermined parallax angle when observing calcified regions while changing the angle by a predetermined angle each time from the observation direction or a predetermined direction (e.g., the imaging direction) accepted at the operation input section 54, may respectively be prepared, and these images for the right eye and images for the left eye, that are prepared by changing the angle by a predetermined angle each time, may respectively be displayed continuously on the stereo display device 80. By continuously displaying images of changed angles in this way, it become easy for the observer to grasp the distribution of the calcified regions.

The above exemplary embodiment describes a case that is applied to radiation images captured by mammography, but the present invention is not limited to the same and may be applied to other radiation imaging devices.

The exemplary embodiment describes a case in which radiations are irradiated individually from different positions such that two radiation images are captured, and three-dimensional information is generated on the basis of the two captured radiation images. However, the present invention is not limited to the same. Three or more radiation images may be captured, and three-dimensional information may be generated on the basis of the three or more captured radiation images.

Although the above exemplary embodiment describes a case in which calcified regions are identified and displayed as lesions, the present invention is not limited to the same. For example, a tumor or another lesion may be identified and displayed.

The above exemplary embodiment describes a case of using the stereo display device 80 in which the two display sections 82 are disposed so as to be lined-up vertically, but the present invention is not limited to the same. For example, an image for the right eye and an image for the left eye may be displayed individually at the odd-numbered lines and the even-numbered lines of a single display section at which the polarization directions of the display lights are orthogonal at the odd-numbered lines and the even-numbered lines. The displayed colors at the image for the right eye and the image for the left eye may be changed, and stereoscopic viewing may be carried out by using glasses that transmit different colors at the right lens and the left lens.

The exemplary embodiment describes a case in which digital image information expressing a radiation image is directly obtained by the radiation detector 42, but the present invention is not limited to the same. For example, radiation may be irradiated onto a cassette or the like that incorporates therein an imaging plate, an X-ray film, or the like, and the digital image information may be obtained by reading the imaging plate or the X-ray film incorporated in the cassette.

A case is described in the above exemplary embodiment in which three-dimensional information is generated from two radiation images at the image processing device 50, and an image for the right eye and an image for the left eye are prepared on the basis of that three-dimensional information. However, the present invention is not limited to the same. For example, processing that generates three-dimensional information from two radiation images may be carried out at the imaging device controller 46 of the radiation imaging device 10 or at another image processing device, and the image processing device 50 may receive the generated three-dimensional information and store it in the HDD 66. The three-dimensional information may be stored in a storage device equipped with a storage unit such as an HDD or the like, and the image processing device 50 may access the three-dimensional information stored in the storage unit of this storage device, and prepare the image for the right eye and the image for the left eye on the basis of this three-dimensional information.

In accordance with a first aspect of the present invention, there is provided an image processing device including: an acquiring unit that acquires image information, the image information expressing a plurality of radiation images that are captured by radiations being irradiated from different positions from radiation sources onto a region of a subject that is an object of imaging; an identification unit that identifies lesions that are objects of observation within each of the plurality of radiation images that are expressed by the image information acquired by the acquiring unit; a generating unit that determines correspondence relationships of the lesions identified by the identification unit, and, based on positional relationships of corresponding lesions within the plurality of radiation images and based on positional relationships of the radiation sources at a time of capturing the plurality of radiation images, generates three-dimensional information that expresses positions of the lesions in a three-dimensional space; an accepting unit that accepts a designation of an observation direction in which the lesions are to be observed within the three-dimensional space; a preparing unit that, based on the three-dimensional information, prepares a first image for a right eye and a second image for a left eye, wherein the first and second images are at a predetermined parallax angle when observing the lesions from the observation direction accepted at the accepting unit; and a control unit that controls an image display unit that displays the first image for the right eye and the second image for the left eye that are prepared by the preparing unit.

In this way, in accordance with the first aspect, lesions that are objects of observation are identified within each of the plural radiation images. Correspondence relationships of the identified lesions are determined. Three-dimensional information, that expresses positions of the lesions in a three-dimensional space, is generated based on positional relationships of the corresponding lesions within the plural radiation images and based on positional relationships of the radiation sources at times of capturing the plural radiation images. Therefore, correspondence points relating to the lesions that are the objects of observation of the patient can be found from the plural radiation images. Accordingly, three-dimensional information relating to the lesions can be generated while the amount of radiation to which the subject is exposed is suppressed.

In accordance with the first aspect, the first image for the right eye and the second image for the left eye of a predetermined parallax angle when observing the lesions from the accepted observation direction, are prepared on the basis of the three-dimensional information. Control is carried out so as to display the prepared first image for the right eye and the prepared second image for the left eye at an image display unit. Due thereto, the lesions that are objects of observation can be observed in a stereoscopic view from various directions.

In accordance with a second aspect of the present invention, in the first aspect, the acquiring unit may acquire image information that expresses two radiation images, and based on positional relationships of corresponding lesions within the two radiation images and based on positional relationships of two radiation sources at the time of capturing the two radiation images, the generating unit may generate the three-dimensional information that expresses the positions of the lesions in the three-dimensional space.

In accordance with a third aspect of the present invention, in the first aspect, the accepting unit may accept an enlargement designation to display an image in an enlarged manner, and if a parallax angle computed from a designated enlargement rate is greater than or equal to a threshold value, the preparing unit may prepare a first projected image for a right eye and a second projected image for a left eye by making a parallax angle of the first and second projected images be smaller than the computed parallax angle.

In accordance with a fourth aspect of the present invention, in the first aspect, the identification unit may identify minute calcified clusters as the lesions that are the objects of observation, and identify the lesions by CAD (computer aided detection).

In accordance with a fifth aspect of the present invention, in the first aspect, the preparing unit may prepare a first partial image for a right eye and a second partial image for a left eye, in which the lesions are observed from the observation direction, based on partial images of predetermined regions of the plurality of radiation images that include the lesions, and the control unit may control the image display unit to display the first partial image for the right eye and the second partial image for the left eye, that are prepared by the preparing unit, at positions of the lesions of the first image for the right eye and the second image for the left eye.

In accordance with a sixth aspect of the present invention, in the first aspect, based on the three-dimensional information, the preparing unit may prepare first images for the right eye and second images for the left eye when observing the lesions while incrementally changing an angle by a predetermined angle relative to the observation direction accepted at the accepting unit or a predetermined direction, and the control unit may control the image display unit to successively display the first images for the right eye and the second images for the left eye, that are prepared by the preparing unit, while incrementally changing the angle by the predetermined angle.

In accordance with a seventh aspect of the present invention, in the first aspect, the image display unit may have a first display to display the first image for the right eye and a second display to display the second image for the left eye, and the control unit may control the image display unit to display the first image for the right eye and the second image for the left eye, that are prepared by the preparing unit, respectively on the first and second displays.

In accordance with an eighth aspect of the present invention, there is provided an image processing device including a storage unit that stores three-dimensional information that expresses positions of lesions in a three-dimensional space, the lesions being objects of observation and being identified within each of a plurality of radiation images that are captured by radiations being irradiated from different positions from radiation sources onto a region of a subject that is an object of imaging, whereby correspondence relationships of the lesions are determined, and the three-dimensional information is generated based on positional relationships of corresponding lesions within the plurality of radiation images and based on positional relationships of the radiation sources at a time of capturing the plurality of radiation images; an accepting unit that accepts a designation of an observation direction in which the lesions are to be observed within the three-dimensional space; a preparing unit that, based on the three-dimensional information stored in the storage unit, prepares a first image for a right eye and a second image for a left eye, wherein the first and second images are at a predetermined parallax angle when observing the lesions from the observation direction accepted at the accepting unit; and a control unit that controls an image display unit that displays the first image for the right eye and the second image for the left eye that are prepared by the preparing unit.

In accordance with the eighth aspect, because operation is similar to that of the first aspect, lesions that are objects of observation can be observed in a stereoscopic view from various directions while the amount of radiation to which the subject is exposed is suppressed.

In accordance with a ninth aspect of the present invention, there is provided an image processing system including: a storage device having a storage unit that stores three-dimensional information that expresses positions of lesions in a three-dimensional space, the lesions being objects of observation and being identified within each of a plurality of radiation images that are captured by radiations being irradiated from different positions from radiation sources onto a region of a subject that is an object of imaging, whereby correspondence relationships of the lesions are determined, and the three-dimensional information is generated based on positional relationships of corresponding lesions within the plurality of radiation images and based on positional relationships of the radiation sources at a time of capturing the plurality of radiation images; and an image processing device including: a communication unit that facilitates communication with the storage device, an accepting unit that accepts a designation of an observation direction in which the lesions are to be observed within the three-dimensional space, a preparing unit that, via the communication unit, acquires the three-dimensional information stored in the storage unit of the storage device, and that, based on the three-dimensional information, prepares a first image for a right eye and a second image for a left eye, wherein the first and second images are at a predetermined parallax angle when observing the lesions from the observation direction accepted at the accepting unit, and a control unit that controls an image display unit that displays the first image for the right eye and the second image for the left eye that are prepared by the preparing unit.

In accordance with the ninth aspect, because operation is similar to that of the first aspect, the lesions that are objects of observation can be observed in a stereoscopic view from various directions while the amount of radiation to which the subject is exposed is suppressed.

In accordance with a tenth aspect of the present invention, there is provided an image processing system including: a first image processing device including: an acquiring unit that acquires image information that expresses a plurality of radiation images that are captured by radiations being irradiated from different positions from radiation sources onto a region of a subject that is an object of imaging, an identification unit that identifies lesions that are objects of observation within each of the plurality of radiation images that are expressed by the image information acquired by the acquiring unit, and a generating unit that determines correspondence relationships of the lesions identified by the identification unit, and, based on positional relationships of corresponding lesions within the plurality of radiation images and based on positional relationships of the radiation sources at a time of capturing the plurality of radiation images, generates three-dimensional information that expresses positions of the lesions in a three-dimensional space; a storage unit that stores the three-dimensional information generated by the generating unit; and a second image processing device including: an accepting unit that accepts a designation of an observation direction in which the lesions are to be observed within the three-dimensional space, a preparing unit that acquires the three-dimensional information stored in the storage unit, and that, based on the three-dimensional information, prepares a first image for a right eye and a second image for a left eye, wherein the first and second images are at a predetermined parallax angle when observing the lesions from the observation direction accepted at the accepting unit, and a control unit that controls an image display unit that displays the first image for the right eye and the second image for the left eye that are prepared by the preparing unit.

In accordance with the tenth aspect, because operation is similar to that of the first aspect, the lesions that are objects of observation can be observed in a stereoscopic view from various directions while the amount of radiation to which the subject is exposed is suppressed.

In the tenth aspect, the storage unit may be provided at the first image processing device or the second image processing device. Or, the storage unit may be provided as a storage device that is separate from the first image processing device and the second image processing device.

In accordance with an eleventh aspect of the present invention, a computer readable medium storing a program causing a computer to execute an image processing, the image processing including: acquiring image information that expresses a plurality of radiation images that are captured by radiations being irradiated from different positions from radiation sources onto a region of a subject that is an object of imaging; identifying lesions that are objects of observation within each of the plurality of radiation images that are expressed by the acquired respective image information; determining correspondence relationships of the identified lesions, and, based on positional relationships of corresponding lesions within the plurality of radiation images and based on positional relationships of the radiation sources at a time of capturing the plurality of radiation images, generating three-dimensional information that expresses positions of the lesions in a three-dimensional space; accepting a designation of an observation direction in which the lesions are to be observed within the three-dimensional space; based on the three-dimensional information, preparing a first image for a right eye and a second image for a left eye, wherein the first and second images are at a predetermined parallax angle when observing the lesions from the accepted observation direction; and displaying the prepared first image for the right eye and the prepared second image for the left eye at an image display unit.

In accordance with the eleventh aspect, a computer is made to operate as the image processing device relating to the first aspect. Therefore, the lesions that are objects of observation can be observed in a stereoscopic view from various directions while the amount of radiation to which the subject is exposed is suppressed.

The program relating to the eleventh aspect can be provided in a form of being recorded on a recording medium such as a CD-ROM, a DVD-ROM, or the like.

In the eleventh aspect, a computer may be made to operate as the image processing device relating to the second through seventh aspects. Therefore, the lesions that are objects of observation can be observed in a stereoscopic view from various directions while the amount of radiation to which the subject is exposed is suppressed.

In accordance with the present invention, lesions that are objects of observation can be observed in a stereoscopic view from various directions while the amount of radiation to which a subject is exposed is suppressed.

The structures (see FIG. 1 through FIG. 5) of the radiation imaging system 5, the radiation imaging device 10, the image processing device 50 and the stereo display device 80, that were described in the above exemplary embodiment, are examples. Changes can, of course, be made thereto in accordance with the situation and within a scope that does not deviate from the gist of the present invention.

The flows (see FIG. 8 and FIG. 10) of the processings of the three-dimensional image generating processing program and the stereo image preparing processing program, that were described in the above exemplary embodiment, are examples. Changes can, of course, be made thereto in accordance with the situation and within a scope that does not deviate from the gist of the present invention.

Embodiments of the present invention are described above, but the present invention is not limited to the embodiments as will be clear to those skilled in the art.

What is claimed is:

1. An image processing device comprising:
an acquiring unit that acquires image information, the image information expressing a plurality of radiation images that are captured by radiations being irradiated from different positions from radiation sources onto a region of a subject that is an object of imaging;
an identification unit that identifies lesions that are objects of observation within each of the plurality of radiation images that are expressed by the image information acquired by the acquiring unit;
a generating unit that determines correspondence relationships of the lesions identified by the identification unit, and, based on positional relationships of corresponding lesions within the plurality of radiation images and based on positional relationships of the radiation sources at a time of capturing the plurality of radiation images, generates three-dimensional information that expresses positions of the lesions in a three-dimensional space;
an accepting unit that accepts a designation of an observation direction in which the lesions are to be observed within the three-dimensional space;
a preparing unit that, based on the three-dimensional information, prepares a first image for a right eye and a second image for a left eye, wherein the first and second images are at a predetermined parallax angle when observing the lesions from the observation direction accepted at the accepting unit; and
a control unit that controls an image display unit that displays the first image for the right eye and the second image for the left eye that are prepared by the preparing unit.

2. The image processing device of claim 1, wherein
the acquiring unit acquires image information that expresses two radiation images, and
based on positional relationships of corresponding lesions within the two radiation images and based on positional relationships of two radiation sources at the time of capturing the two radiation images, the generating unit generates the three-dimensional information that expresses the positions of the lesions in the three-dimensional space.

3. The image processing device of claim 1, wherein
the accepting unit accepts an enlargement designation to display an image in an enlarged manner, and
if a parallax angle computed from a designated enlargement rate is greater than or equal to a threshold value, the preparing unit prepares a first projected image for a right eye and a second projected image for a left eye by making a parallax angle of the first and second projected images be smaller than the computed parallax angle.

4. The image processing device of claim 1, wherein the identification unit identifies minute calcified clusters as the lesions that are the objects of observation, and identifies the lesions by CAD (computer aided detection).

5. The image processing device of claim 1, wherein
the preparing unit prepares a first partial image for a right eye and a second partial image for a left eye, in which the lesions are observed from the observation direction, based on partial images of predetermined regions of the plurality of radiation images that include the lesions, and
the control unit controls the image display unit to display the first partial image for the right eye and the second partial image for the left eye, that are prepared by the preparing unit, at positions of the lesions of the first image for the right eye and the second image for the left eye.

6. The image processing device of claim 1, wherein
based on the three-dimensional information, the preparing unit prepares first images for the right eye and second images for the left eye when observing the lesions while incrementally changing an angle by a predetermined angle relative to the observation direction accepted at the accepting unit or a predetermined direction, and
the control unit controls the image display unit to successively display the first images for the right eye and the second images for the left eye, that are prepared by the preparing unit, while incrementally changing the angle by the predetermined angle.

7. The image processing device of claim 1, wherein
the image display unit has a first display to display the first image for the right eye and a second display to display the second image for the left eye, and
the control unit controls the image display unit to display the first image for the right eye and the second image for the left eye, that are prepared by the preparing unit, respectively on the first and second displays.

8. An image processing device comprising:
a storage unit that stores three-dimensional information that expresses positions of lesions in a three-dimensional space, the lesions being objects of observation and being identified within each of a plurality of radiation images that are captured by radiations being irradiated from different positions from radiation sources onto a region of a subject that is an object of imaging, whereby correspondence relationships of the lesions are determined, and the three-dimensional information is generated based on positional relationships of corresponding lesions within the plurality of radiation images and based on positional relationships of the radiation sources at a time of capturing the plurality of radiation images;
an accepting unit that accepts a designation of an observation direction in which the lesions are to be observed within the three-dimensional space;
a preparing unit that, based on the three-dimensional information stored in the storage unit, prepares a first image for a right eye and a second image for a left eye, wherein the first and second images are at a predetermined parallax angle when observing the lesions from the observation direction accepted at the accepting unit; and
a control unit that controls an image display unit that displays the first image for the right eye and the second image for the left eye that are prepared by the preparing unit.

9. An image processing system comprising:
a storage device having a storage unit that stores three-dimensional information that expresses positions of lesions in a three-dimensional space, the lesions being objects of observation and being identified within each of a plurality of radiation images that are captured by radiations being irradiated from different positions from radiation sources onto a region of a subject that is an object of imaging, whereby correspondence relationships of the lesions are determined, and the three-dimensional information is generated based on positional relationships of corresponding lesions within the plurality of radiation images and based on positional relationships of the radiation sources at a time of capturing the plurality of radiation images; and
an image processing device including:
a communication unit that facilitates communication with the storage device,
an accepting unit that accepts a designation of an observation direction in which the lesions are to be observed within the three-dimensional space,
a preparing unit that, via the communication unit, acquires the three-dimensional information stored in the storage unit of the storage device, and that, based on the three-dimensional information, prepares a first image for a right eye and a second image for a left eye, wherein the first and second images are at a predetermined parallax angle when observing the lesions from the observation direction accepted at the accepting unit, and
a control unit that controls an image display unit that displays the first image for the right eye and the second image for the left eye that are prepared by the preparing unit.

10. An image processing system comprising:
a first image processing device including:
an acquiring unit that acquires image information that expresses a plurality of radiation images that are captured by radiations being irradiated from different positions from radiation sources onto a region of a subject that is an object of imaging,
an identification unit that identifies lesions that are objects of observation within each of the plurality of radiation images that are expressed by the image information acquired by the acquiring unit, and
a generating unit that determines correspondence relationships of the lesions identified by the identification unit, and, based on positional relationships of corresponding lesions within the plurality of radiation images and based on positional relationships of the radiation sources at a time of capturing the plurality of radiation images, generates three-dimensional information that expresses positions of the lesions in a three-dimensional space;
a storage unit that stores the three-dimensional information generated by the generating unit; and
a second image processing device including:
an accepting unit that accepts a designation of an observation direction in which the lesions are to be observed within the three-dimensional space,
a preparing unit that acquires the three-dimensional information stored in the storage unit, and that, based on the three-dimensional information, prepares a first image for a right eye and a second image for a left eye, wherein the first and second images are at a predetermined parallax angle when observing the lesions from the observation direction accepted at the accepting unit, and
a control unit that controls an image display unit that displays the first image for the right eye and the second image for the left eye that are prepared by the preparing unit.

11. A computer readable medium storing a program causing a computer to execute an image processing, the image processing comprising:
acquiring image information that expresses a plurality of radiation images that are captured by radiations being irradiated from different positions from radiation sources onto a region of a subject that is an object of imaging;
identifying lesions that are objects of observation within each of the plurality of radiation images that are expressed by the acquired respective image information;
determining correspondence relationships of the identified lesions, and, based on positional relationships of corresponding lesions within the plurality of radiation images and based on positional relationships of the radiation sources at a time of capturing the plurality of radiation images, generating three-dimensional information that expresses positions of the lesions in a three-dimensional space;
accepting a designation of an observation direction in which the lesions are to be observed within the three-dimensional space;
based on the three-dimensional information, preparing a first image for a right eye and a second image for a left eye, wherein the first and second images are at a predetermined parallax angle when observing the lesions from the accepted observation direction; and
displaying the prepared first image for the right eye and the prepared second image for the left eye at an image display unit.

12. The computer readable medium of claim 11, wherein
acquiring image information includes acquiring respective image information that expresses two radiation images, and
generating the three-dimensional information includes generating, based on positional relationships of corresponding lesions within the two radiation images and based on positional relationships of the radiation sources at a time of capturing the two radiation images, the three-dimensional information that expresses the positions of the lesions in the three-dimensional space.

13. The computer readable medium of claim 11, wherein
accepting the designation includes accepting an enlargement designation to display an image in an enlarged manner, and
preparing the first and second images includes, if a parallax angle computed from a designated enlargement rate is greater than or equal to a threshold value, preparing a first projected image for a right eye and a second projected image for a left eye by making a parallax angle of the first and second projected images be smaller than the computed parallax angle.

14. The computer readable medium of claim 11, wherein the identifying the lesions includes identifying minute calcified clusters as the lesions that are the objects of observation, and identifying the lesions by CAD (computer aided detection).

15. The computer readable medium of claim 11, wherein
preparing the first and second images includes preparing a first partial image for a right eye and a second partial image for a left eye, in which the lesions are observed from the observation direction, based on partial images of predetermined regions of the plurality of radiation images that include the lesions, and
displaying the first and second images includes displaying the prepared first partial image for the right eye and the prepared second partial image for the left eye at the positions of the lesions of the first image for the right eye and the second image for the left eye.

16. The computer readable medium of claim 11, wherein
preparing the first and second images includes preparing, based on the three-dimensional information, first images for the right eye and second images for the left eye when observing the lesions while incrementally changing an angle by a predetermined angle relative to the accepted observation direction or a predetermined direction, and
displaying the first and second images includes successively displaying, at the image display unit, the first images for the right eye and the second images for the left eye that are prepared while incrementally changing the angle by the predetermined angle.

17. The computer readable medium of claim 11, wherein
the image display unit has a first display to display the first image for the right eye and a second display to display the second image for the left eye, and
displaying the first and second images includes displaying the prepared first image for the right eye and the prepared second image for the left eye respectively on the first and second displays of the image display unit.
